(19) United States
(12) Patent Application Publication
(10) Pub. No.: US 2007/0288989 A1
(43) Pub. Date: Dec. 13, 2007

(54) Method, electronic device, apparatus, system and computer program product for updating an electronic device security policy

(75) Inventors: Jyrki Aarnos, Kangasala (FI); Gabor Pecsy, Budapest (HU); Jari S. Valimaki, Kangasala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/450,932

(22) Filed: Jun. 9, 2006

(51) Int. Cl. H04L 9/00

(52) U.S. Cl. 726/1

(57) ABSTRACT

A convenient and safe way is provided to update the security policy associated with an electronic device after a user has purchased the device and taken it away for use. In particular, a scripting tool is provided that can be used to create a policy update script that describes the desired modifications to the electronic device security policy. An OSGi resource processor, referred to as a Policy Update Resource Processor, is further provided, wherein the Policy Update Resource Processor is located on the electronic device and is configured to carry out the security policy modifications outlined in the policy update script.

### FIELD

Exemplary embodiments of the present invention relate, generally, to updating an electronic device security policy and, in particular, to an OSGi Policy Update Resource Processor that can be used to effect the policy updates after a user has taken possession of the device for personal use.

### BACKGROUND

OSGi, or the Open Services Gateway initiative, is an open standards organization that specified a Java-based service platform that can be remotely managed. More specifically, the OSGi service platform enables the life cycle of the software components of a device, to which the service platform has been added, to be managed from anywhere in the network. The software components, which may provide services to other software components operating on the electronic device, comprise applications that are capable of dynamically discovering and using other software components or applications. These components can be remotely installed, started, stopped, updated and uninstalled without requiring a reboot or otherwise disrupting the operation of the device.

The interaction of the various software components is controlled by the security policy associated with the electronic device on which the components are installed. In particular, the security policy controls how the components interact with each other, what kinds of services respective software components can use, what kinds of services respective software components can provide, and how the software components can access various resources of the electronic device.

Each software component may be associated with a respective permission, wherein in order to access the service provided by the software component, other software components or applications of the electronic device must be granted the corresponding permission. However, permissions associated with new software components that are installed after the electronic device has left the hands of the manufacturer or network operator, would not have been granted to the other components of the electronic device. In other words, the security policy associated with the electronic device would not include any reference to the new software component or its corresponding permission. In addition, the new services would similarly not have been granted the requisite permission(s) for accessing services provided by other software components of the electronic device.

As a result, in order for other applications and components of the electronic device to be able to access the new service, and vice versa, the electronic device security policy must be updated or extended to grant the requisite permission(s) to the appropriate components or applications.

Other situations may similarly exist where it would be desirable for parties other than the manufacture or network operator, to be able to modify the existing security policy of the electronic device (i.e., in addition to where a new software component is introduced). For example, a software developer may desire to change the security policy on one or more electronic devices in order to test various applications he or she is developing. In addition, companies that provide their employees with mobile devices (e.g., cell phones and/or PDAs) may have specific software that can only be run on that company's devices and require special permissions within the device. It may be desirable for the company to be able to install the necessary rights to the mobile device at the same time the software is being installed.

Currently, however, in order to modify the electronic device security policy, a party must have AllPermission, a Java-based permission that grants permission to access everything on the electronic device, or a similar and equally powerful permission. However, manufacturers and, in some instances, network operators are generally the only parties with such a powerful permission. This makes it nearly impossible for any party other than the manufacturer or network operator to modify the existing security policy.

A need, therefore, exists for a way for parties not limited to the device manufacturer or network operator to modify the existing security policy of an electronic device after a user has taken possession of the electronic device.

### BRIEF SUMMARY

In general, exemplary embodiments of the present invention provide an improvement over the known prior art by, among other things, providing a convenient and safe way to update the security policy associated with an electronic device, such as a cellular telephone, personal digital assistant (PDA), personal computer (PC), laptop, pager, television, or the like, or one or more electronic devices operating on a motor vehicle, after a user has purchased the device and taken it away for use. In particular, exemplary embodiments provide a scripting tool that can be used to create a policy update script, or resource application or file, that describes the desired modifications to an electronic device security policy. Exemplary embodiments further provide an OSGi resource processor, referred to as a Policy Update Resource Processor, that is located on the electronic device and is configured to carry out the security policy modifications outlined in the policy update script. In particular, in one exemplary embodiment, the modifications may be those necessary to provide a new software component, with which the script corresponds, the requisite permissions to access other software components and resources available on the electronic device. The script may also describe how the security policy should be modified, in turn, to provide the other software components access to the services of the new software component.

In accordance with one aspect, a method is provided of updating a security policy associated with an electronic device. In one exemplary embodiment, the method includes: (1) receiving a policy update script comprising one or more modifications to the security policy; and (2) processing the policy update script using an OSGi policy update resource processor in order to effect the modifications to the security policy.

According to another aspect, an electronic device is provided that is capable of updating a security policy associated with the electronic device. In one exemplary embodiment the electronic device includes an OSGi policy update resource processor that is configured to receive a policy update script comprising one or more modifications to the security policy and to process the policy update script received in order to effect the modifications to the security policy.

According to yet another aspect, an apparatus is provided that is capable of updating a security policy associated with an electronic device. In one exemplary embodiment, the apparatus includes a processor and a memory in communication with the processor that stores an application executable by the processor, wherein the application is configured, upon execution, to: (1) generate a policy update script comprising one or more modifications to the security policy, wherein the policy update script is capable of being processed by an OSGi policy update resource processor in order to effect the modifications; and (2) transmit the policy update script.

In accordance with another aspect, a system is provided for updating a security policy associated with an electronic device. In one exemplary embodiment, the system includes: (1) a network entity configured to generate a policy update script comprising one or more modifications to the security policy and to transmit the policy update script; and (2) an electronic device configured to receive the policy update script, wherein the electronic device comprises an OSGi policy update resource processor that is configured to process the policy update script received in order to effect the modifications to the security policy.

In accordance with yet another aspect, a computer program product is provided for updating a security policy associated with an electronic device. The computer program product contains at least one computer-readable storage medium having computer-readable program code portions stored therein. The computer-readable program code portions of one exemplary embodiment include: (1) a first executable portion for receiving a policy update script comprising one or more modifications to the security policy; and (2) a second executable portion for processing the policy update script using an OSGi policy update resource processor in order to effect the modifications to the security policy.

### BRIEF DESCRIPTION OF THE SEVERAL VIEWS OF THE DRAWING(S)

Having thus described exemplary embodiments of the invention in general terms, reference will now be made to the accompanying drawings, which are not necessarily drawn to scale, and wherein:

FIG. 1 is a flow chart illustrating the steps which may be taken in order to update an electronic device security policy in accordance with exemplary embodiments of the present invention;

FIG. 2 is a block diagram of one type of system that would benefit from exemplary embodiments of the present invention;

FIG. 3 is a schematic block diagram of an entity capable of operating as a device associated with a software developer and/or an authorized policy administrator in accordance with exemplary embodiments of the present invention;

FIG. 4 is a schematic block diagram of an electronic device capable of operating in accordance with an exemplary embodiment of the present invention;

### DETAILED DESCRIPTION

Exemplary embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Method of Updating Electronic Device Security Policy

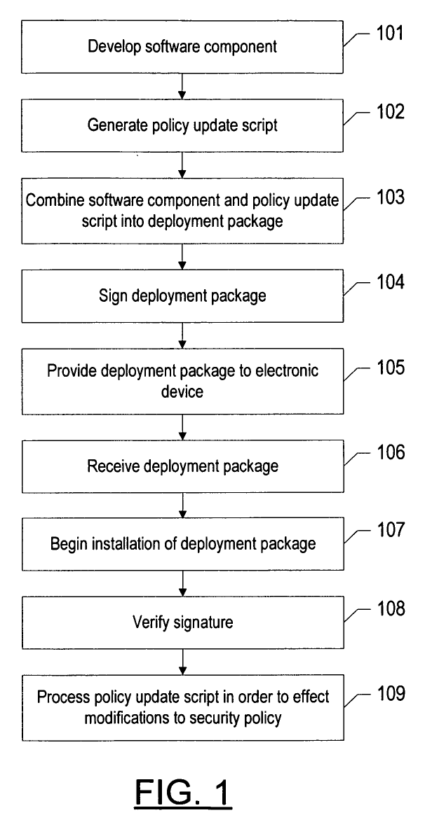

Reference is now made to FIG. 1, which illustrates the steps which may be taken in order to update the security policy associated with a particular electronic device (e.g., cellular telephone, PDA, PC, laptop, pager, television, or one or more electronic devices operating on a motor vehicle.). As shown, in one exemplary embodiment, the process may begin when a party, such as a software developer, creates or develops a software component or application to be installed on the electronic device. (Step 101). As discussed above, software components are applications operating on an electronic device that may provide services to other components on the device and are likewise capable of dynamically discovering and using services of those other software components and applications. As is discussed in more detail below, Step 101 is optional. In other words exemplary embodiments of the present invention are not limited to instances where new software components are being developed for deployment on electronic devices.

Once the software component has been developed, in Step 102, a policy update script is generated that describes the modifications that must be made to the electronic device security policy in order to enable the new software component to access other services and resources of the electronic device, and vice versa (i.e., the modifications grant the appropriate permissions to the various components). The policy update script may, for example, be in the form of an Extensible Markup Language (XML) file, or the like.

The developed software component and the corresponding policy update script are then combined, in Step 103 into a deployment (or installation) package for deployment on the device. The deployer (or party responsible for creating the deployment package and providing it to the electronic device, which may or may not be the software developer), in Step 104 signs the package (i.e., incorporates a digital signature, such as a private key, with the package). The signature will be used to verify whether and to what extent the signer (i.e., the deployer) is authorized to modify the electronic device security policy; thus providing increased security to the policy updating process. In one exemplary embodiment, different parties may be provided with different levels of authorization. For example, where one party may have authorization to make wholesale modifications to the existing security policy, other parties may have only restricted access.

The deployment or installation package, including the software component, the policy update script and the signature, is then provided to the device in Step 105. In one exemplary embodiment, this step is performed where the user of the electronic device initiates the download of the software component over a network, such as a wide area network (WAN), or the like. Alternatively, the software component may be pushed to the electronic device. As one of ordinary skill in the art will recognize, the software component may be transmitted via any number of mechanisms, including, for example, over Bluetooth, a USB cable, infrared, or even a multimedia card (MMC), without departing from the spirit and scope of exemplary embodiments of the present invention.

Regardless of how the deployment package is received by the electronic device (in Step 106), upon receipt, installation of the deployment package begins (Step 107). In one exemplary embodiment, at the commencement of the installation process, the deployer's signature is verified in order to determine, as stated above, whether and to what extent the party transmitting the deployment package is in fact authorized to modify the existing security policy of the mobile device (Step 108). Assuming the signature is verified and that the deployer is authorized (based on the existing electronic device security policy), in Step 109, the policy update script is processed in order to effect the modifications to the security policy that are described by or included in the policy update script.

In particular, according to the OSGi specification, a deployment service exists on the electronic device that is configured to process deployment or installation packages received by the electronic device. This deployment service comprises one or more plug-ins called resource processors, wherein different resource processors are capable of processing different installation packages. In particular, resource processors, or software components that may be located on the device itself or within the deployment package to be installed, handle the lifecycle of specific resource types by processing the resource to create artifacts that are then removed when the resource is dropped. The use of a plug-in architecture for the deployment service is beneficial since it enables the use of multiple types of resources in the installation package (i.e., for each new type of resource a new resource processor, or plug-in, can be added where necessary).

According to exemplary embodiments of the present invention, a new plug-in or OSGi resource processor, referred to as the Policy Update Resource Processor is included in the deployment service. The Policy Update Resource Processor is configured to recognize the policy update script and to conduct the necessary security policy update according to the script. In one exemplary embodiment, usage of the Policy Update Resource Processor is protected by a new Java 2 permission, such that only deployment packages assigned this new permission can run this new processor. The assignment of the Java 2 permission is carried out based on the signature information of the deployment package. In other words, verifying the signature incorporated with the package in order to determine whether, and to what extent, the signer is authorized to modify the security policy, in essence verifies that the party signing the package has been given the new permission.

As mentioned briefly above, exemplary embodiments of the present invention are not limited to situations where a new software component is to be installed on the electronic device. In contrast, the policy update script may be used any time a party desires to modify the existing security policy and is authorized to do so. In one exemplary embodiment, rather than including the policy update script in a deployment package for a new software component, a manufacturer or operator may create an “empty” deployment or installation package containing only the policy update script (thus eliminating Step 101). The manufacturer or operator could then provide the package to the appropriate parties, such as the software developer. Using this technique, manufacturers and operators would no longer be required to run the actual installation or remote policy management themselves. The below exemplary use case provides an example of where an empty deployment package may be used.

### Exemplary Use Case:

The following describes a scenario in which exemplary embodiments of the present invention would be particularly useful. As discussed above, downloadable applications and software components are executed under the control of the electronic device security policy and the OSGi service platform. In particular, software components have limited capabilities (e.g., in terms of what services or resources they can access, and vice versa), which are often granted based on the digital signatures authenticating the application code and the electronic device security policy.

At the time of development of these applications, however, developers need special access to the device (i.e., they may require special capabilities for their applications). Developer permissions may, therefore, be granted for particular devices, which may be identified by the device's International Mobile Equipment Identification (IMEI). Granting these permissions is a complex and expensive process and only a few authorized parties are authorized to do so.

For example, one method of granting the requisite permissions is based on the creation of different developer platforms, wherein a special developer certificate may be locked to the IMEIs of one or more specific devices. Developers use private keys corresponding to these certificates when signing their applications. The applications can then be executed on the devices with the listed IMEIs. One drawback to this method, however, is that it assumes that the root certificates that can be used for signing the developer certificates have been provided to the one or more devices at the time of manufacture. In addition, a special mechanism is required that can recognize that the developer certificate is locked to particular IMEI numbers and act accordingly.

Exemplary embodiments of the present invention provide a better solution to the issue of providing developers with special permissions (i.e., one that overcomes at least the above-referenced drawbacks) by combining the conditional permission framework of the OSGi Service Platform with the policy update scripts described above. In particular, the OSGi Service Platform Release 4 is extending the standard Java 2 security system with a conditional permission framework that would allow granting permissions based on different conditions. OSGi policies, therefore, comprise a list of conditions, wherein if those conditions are met, then a certain permission is granted. One such condition, referred to as the IMEICondition, ties the granting of certain permission to the IMEI of the device. This allows certain permissions to be granted on certain categories of devices, or on only single devices.

Exemplary embodiments of the present invention combine the IMEICondition with the use of a policy update script in order to create terminal-specific scripts that can be used to update the security policies of only specific electronic devices (e.g., devices on which software developers wish to test their software—i.e., devices the developer wishes to turn into developer devices).

In particular, according to exemplary embodiments of the present invention, a developer may provide the IMEIs of the devices they would like to use as developer devices to an authorized policy administrator of those devices (i.e., to a party with authorization to create policy update scripts that will be read by a Policy Update Resource Processor on the device in order to modify the existing security policy). The authorized policy administrator, in turn, creates a policy update script granting the requisite permissions (e.g., AllPermission) to the developers and includes the IMEICondition in the script. In other words, the permission is granted conditionally only for those devices identified by their IMEI. The authorized policy administrator puts the script into a deployment package (i.e., the standard installation scripts of the OSGi platform), signs the package with his private key and then returns the signed package to the developer. Upon receipt of the package, the developer can execute the package on the device, which, in turn, executes the policy update script. The execution of the deployment package is authorized, based on the authorized policy administrator's signature, to perform the policy update script. From that point on, the developer will have all of the rights described in the policy update script, with respect to the device(s) identified by their IMEIs. If the deployment package were to be executed with respect to a device not identified in the IMEICondition, the device's security policy would not be affected, since the condition would not be met and, therefore, the permission would not be granted.

The foregoing solution is beneficial because it enables parties having rights to update an electronic device security policy (e.g., the device manufacturer) to delegate that right to, for example, a network operator that can then create developer devices in their developer community. It further eliminates the need to create developer certificates and lock those certificates to the IMEIs of various devices. Permissions can be granted selectively, providing the policy administrator with more fine-grained control than in the case of developer certificates.

### Overall System and Mobile Device:

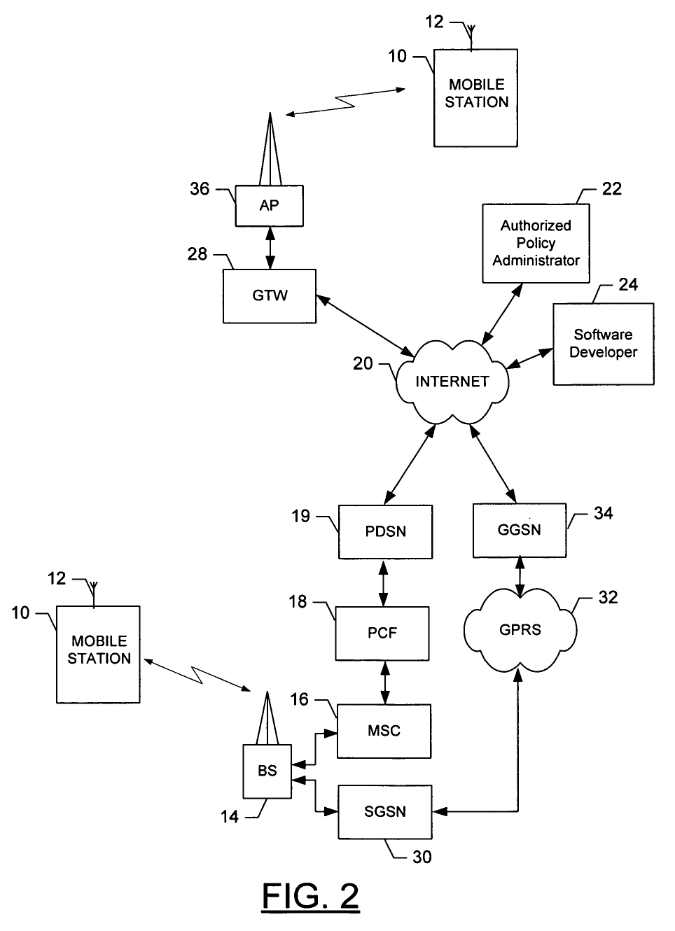

Referring to FIG. 2, an illustration of one type of system that would benefit from exemplary embodiments of the present invention is provided. As shown in FIG. 2, the system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include devices corresponding with an Authorized Policy Administrator 22 (i.e., a party having authorization to create policy update scripts that will be read by a Policy Update Resource Processor on the mobile station in order to modify the existing security policy) and/or a Software Developer 24, discussed above. As will be appreciated, the processing elements can comprise any of a number of processing devices, systems or the like capable of operating in accordance with embodiments of the invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the invention, as should dual or higher mode mobile stations (e.g., digital/analog or TDMA/CDMA/analog phones).

One or more mobile stations 10 (as well as one or more processing elements, although not shown as such in FIG. 2) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements (e.g., devices associated with the Authorized Policy Administrator 22 and/or Software Developer 24) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the invention. Thus, use of any such terms should not be taken to limit the spirit and scope of embodiments of the invention.

Although not shown in FIG. 2, in addition to or in lieu of coupling the mobile stations 10 to one or more processing elements (e.g., devices associated with an Authorized Policy Administrator 22 and/or Software Developer 24) across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques. Further, the mobile station 10 and the processing elements can be coupled to one or more electronic devices, such as printers, digital projectors and/or other multimedia capturing, producing and/or storing devices (e.g., other terminals).

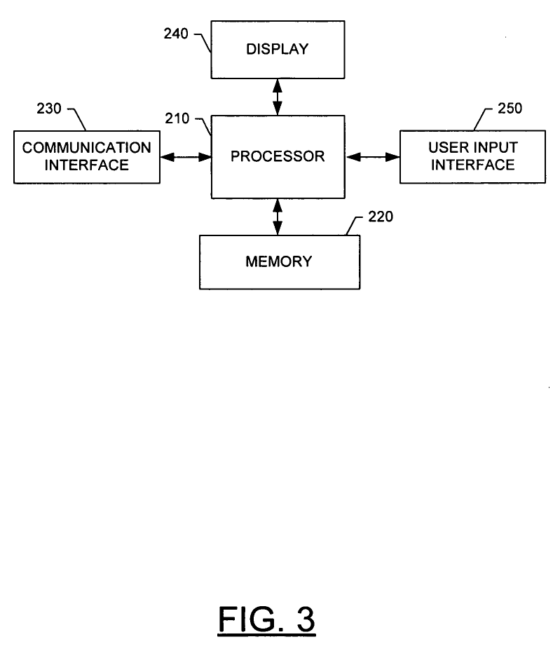

Referring now to FIG. 3, a block diagram of an entity capable of operating as a device associated with an Authorized Policy Processor 22 and/or a Software Developer 24 is shown in accordance with one embodiment of the invention. The entity capable of operating as a device associated with an Authorized Policy Processor 22 and/or a Software Developer 24 includes various means for performing one or more functions in accordance with exemplary embodiments of the invention, including those more particularly shown and described herein. In particular, the entity capable of operating as the device associated with either or both the Authorization Policy Processor 22 or the Software Developer 24 may include means for performing one or more of Steps 101-105 of FIG. 1 discussed above. It should be understood, however, that one or more of the entities may include alternative means for performing one or more like functions, without departing from the spirit and scope of embodiments of the invention. As shown, the entity capable of operating as a device associated with an Authorized Policy Processor 22 and/or a Software Developer 24 can generally include means, such as a processor 210 connected to a memory 220, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the invention. For example, the memory of the entity capable of operating as the device associated with the Authorized Policy Processor 22 may store computer program code for generating a policy update script and signing a deployment or installation package including the generated script prior to transmitting it to, for example, the entity capable of operating as the device associated with the Software Generator 24.

In addition to the memory 220, the processor 210 can also be connected to at least one interface or other means for displaying, transmitting and/or receiving data, content or the like (e.g., for transmitting and/or receiving a generated software component, policy update script and/or signature). In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

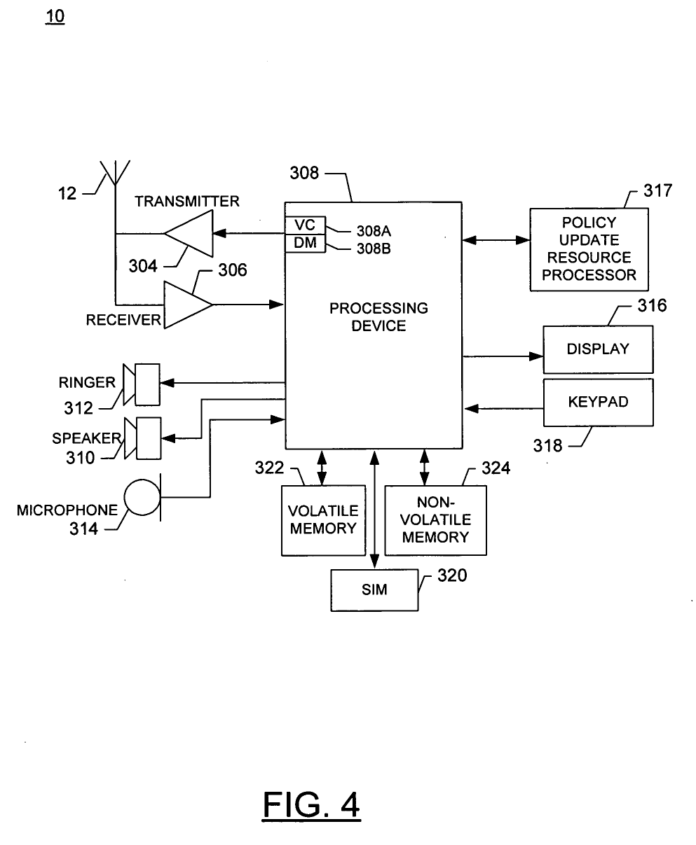

Reference is now made to FIG. 4, which illustrates one type of electronic device that would benefit from embodiments of the invention. As shown, the electronic device may be a mobile station 10, and, in particular, a cellular telephone. It should be understood, however, that the mobile station illustrated and hereinafter described is merely illustrative of one type of electronic device that would benefit from embodiments of the invention and, therefore, should not be taken to limit the scope of embodiments of the invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the invention.

The mobile station includes various means for performing one or more functions in accordance with exemplary embodiments of the invention, including those more particularly shown and described herein. It should be understood, however, that one or more of the entities may include alternative means for performing one or more like functions, without departing from the spirit and scope of embodiments of the invention. More particularly, for example, as shown in FIG. 3, in addition to an antenna 302, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the invention, the memory may store computer program code for performing any combination of Steps 106-109 of FIG. 1 discussed above. In particular, the memory may store computer program code for receiving a policy update script including one or more modifications to the security policy and for processing the policy update script using an OSGi policy update resource processor 317, also included in the electronic device, in order to effect the modifications to the security policy. In general, the OSGi policy update resource processor 317 is a software component that is capable of handing the life cycle of a particular resource type by processing the resource to create artifacts that are then removed when the resource is dropped.

The system, method, electronic device, network entity and computer program product of exemplary embodiments of the invention are primarily described in conjunction with mobile communications applications. It should be understood, however, that the system, method, electronic device, network entity and computer program product of embodiments of the invention can be utilized in conjunction with a variety of other applications, both in the mobile communications industries and outside of the mobile communications industries. For example, the system, method, electronic device, network entity and computer program product of exemplary embodiments of the invention can be utilized in conjunction with wireline and/or wireless network (e.g., Internet) applications.

### Conclusion:

As described above and as will be appreciated by one skilled in the art, embodiments of the invention may be configured as a system, method, electronic device, network entity and computer program product. Accordingly, embodiments of the invention may be comprised of various means including entirely of hardware, entirely of software, or any combination of software and hardware. Furthermore, embodiments of the invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these exemplary embodiments of the invention pertain having the benefit of the teachings presented in the foregoing descriptions and the associated drawings. Therefore, it is to be understood that exemplary embodiments of the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of updating a security policy associated with an electronic device, said method comprising:
receiving a policy update script comprising one or more modifications to the security policy; and
processing the policy update script using an OSGi policy update resource processor in order to effect the modifications to the security policy.

2. The method of claim 1, wherein the policy update script further comprises a signature corresponding with a transmitting party from whom the policy update script is received.

3. The method of claim 2 further comprising:
verifying the signature in order to determine whether the transmitting party is authorized to modify the security policy.

4. The method of claim 1 further comprising:
receiving a new software component associated with the policy update script; and
installing the new software component.

5. The method of claim 4, wherein the modifications to the security policy grant the new software component permission to access one or more existing software applications installed on the electronic device.

6. The method of claim 5, wherein the modifications further grant one or more existing software components permission to access the new software component.

7. An electronic device capable of updating a security policy associated with the electronic device, said electronic device comprising:
an OSGi policy update resource processor configured to receive a policy update script comprising one or more modifications to the security policy and to process the policy update script received in order to effect the modifications to the security policy.

8. The electronic device of claim 7, wherein the policy update script further comprises a signature corresponding with a transmitting party from whom the policy update script is received.

9. The electronic device of claim 8, wherein the resource processor is further configured to verify the signature in order to determine whether the transmitting party is authorized to modify the security policy.

10. The electronic device of claim 9, wherein the resource processor is further configured to determine, based at least in part on the signature, an extent to which the transmitting party is authorized to modify the security policy.

11. The electronic device of claim 7 further comprising:
a means to receive a new software component associated with the policy update script; and
a means to install the new software component on the electronic device.

12. The electronic device of claim 10, wherein the modifications to the security policy grant the new software component permission to access one or more existing software applications installed on the electronic device, and wherein the modifications further grant one or more existing software components permission to access the new software component.

13. An apparatus capable of updating a security policy associated with an electronic device, said apparatus comprising:
a processor; and
a memory in communication with the processor, said memory storing an application executable by the processor, wherein the application is configured, upon execution, to:
generate a policy update script comprising one or more modifications to the security policy, said policy update script capable of being processed by an OSGi policy update resource processor in order to effect the modifications; and
transmit the policy update script.

14. The apparatus of claim 13, wherein the application is further configured, upon execution, to associate a signature with the policy update script, said signature capable of being verified in order to determine whether a party associated with the apparatus is authorized to modify the security policy.

15. The apparatus of claim 13, wherein the application is further configured, upon execution, to combine the policy update script with a new software component to be installed on the electronic device, said application further configured, upon execution, to transmit the new software component to the electronic device with the policy update script.

16. The apparatus of claim 15, wherein the modifications to the security policy grant the new software component permission to access one or more existing software applications installed on the electronic device.

17. The apparatus of claim 16, wherein the modifications further grant one or more existing software components permission to access the new software component.

18. The apparatus of claim 15, wherein the application is further configured, upon execution, to generate the new software component.

19. A system for updating a security policy associated with an electronic device, said system comprising:
an apparatus configured to generate a policy update script comprising one or more modifications to the security policy, said apparatus further configured to transmit the policy update script; and
an electronic device configured to receive the policy update script, said electronic device comprising an OSGi policy update resource processor configured to process the policy update script received in order to effect the modifications to the security policy.

20. The system of claim 19, wherein the apparatus is further configured to associate a signature with the policy update script, such that transmitting the policy update script comprises transmitting the policy update script and the associated signature.

21. The system of claim 20, wherein the electronic device is further configured to verify the signature in order to determine whether a party associated with the apparatus is authorized to modify the security policy.

22. The system of claim 19, wherein the apparatus is further configured to combine the policy update script with a new software component and to transmit the new software component with the policy update script to the electronic device.

23. The system of claim 22, wherein the electronic device is further configured to receive the new software component and to install the software component.

24. The system of claim 23, wherein the modifications to the security policy grant the new software component permission to access one or more existing software applications installed on the electronic device.

25. The system of claim 24, wherein the modifications further grant one or more existing software components permission to access the new software component.

26. The system of claim 22, wherein the apparatus is further configured to generate the new software component.

27. A computer program product for updating a security policy associated with an electronic device, wherein the computer program product comprises at least one computer-readable storage medium having computer-readable program code portions stored therein, said computer-readable program code portions comprising:
a first executable portion for receiving a policy update script comprising one or more modifications to the security policy; and
a second executable portion for processing the policy update script using an OSGi policy update resource processor in order to effect the modifications to the security policy.

28. The computer program product of claim 27, wherein the policy update script further comprises a signature corresponding with a transmitting party from whom the policy update script is received.

29. The computer program product of claim 28, wherein the computer-readable program code portions further comprise:
a third executable portion for verifying the signature in order to determine whether the transmitting party is authorized to modify the security policy.

30. The computer program product of claim 27, wherein the computer-readable program code portions further comprise:
a third executable portion for receiving a new software component associated with the policy update script; and
a fourth executable portion for installing the new software component.

31. The computer program product of claim 30, wherein the modifications to the security policy grant the new software component permission to access one or more existing software applications installed on the electronic device.

32. The computer program product of claim 31, wherein the modifications further grant one or more existing software components permission to access the new software component.

33. An apparatus for updating a security policy associated with an electronic device, said apparatus comprising:
a means for receiving a policy update script comprising one or more modifications to the security policy; and
a means for processing the policy update script using an OSGi policy update resource processor in order to effect the modifications to the security policy.

34. The apparatus of claim 33, wherein the policy update script further comprises a signature corresponding with a transmitting party from whom the policy update script is received, said apparatus further comprising:
a means for verifying the signature in order to determine whether the transmitting party is authorized to modify the security policy.

35. The apparatus of claim 33 further comprising:
a means for receiving a new software component associated with the policy update script; and
a means for installing the new software component, wherein the modifications to the security policy grant the new software component permission to access one or more existing software applications installed on the electronic device and one or more existing software components permission to access the new software component.
